(19) United States
(12) Patent Application Publication
(10) Pub. No.: US 2006/0125929 A1
(43) Pub. Date: Jun. 15, 2006

(54) Wireless communication terminal having function for automatically controlling flash and method thereof

(76) Inventor: Sung-Hwan Choi, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/303,058

(22) Filed: Dec. 13, 2005

(30) Foreign Application Priority Data
Dec. 15, 2004 (KR) 10-2004-0106264

(51) Int. Cl. H04N 5/232

(52) U.S. Cl. 348/211.2

(57) ABSTRACT

A wireless communication terminal having a function for automatically controlling a flash and a method thereof are disclosed. The wireless communication terminal includes: an image capturing unit for obtaining an image of an object in real-time, converting the obtained image to an electric image signal, and automatically controlling a gain according to brightness of the electric image signal; an input unit for receiving an image capturing signal; a controller for confirming a gain value of an image signal which is automatically controlled in the image capturing unit when the image capturing signal is inputted through the input unit, comparing the confirmed gain value of the image signal with a predetermined threshold value, and generating a control signal according to the comparison signal; and a light emitting unit for emitting light in response to the control signal from the controller.

### FIELD OF THE INVENTION

The present invention relates to a wireless communication terminal having a function for automatically controlling a flash and a method thereof; and, more particularly, to a wireless communication terminal having a function for automatically turning on/off a flash according to brightness of an image signal using a register value, which is a gain value of a programmable gain amplifier (PGA), used to operate an image capturing unit of the wireless communication terminal without requiring a user's operation or additional equipments.

### DESCRIPTION OF RELATED ARTS

A wireless communication terminal denotes a potable terminal capable of transmitting/receiving various data including voice, text, or image through a wireless communication network, such as a mobile communication terminal, a personal communication service (PCS) phone, a personal digital assistant (PDA), a smart phone, a wireless local area network (LAN) terminal, and a next generation mobile communication terminal (IMT-2000).

Mobility is one of representative advantages of the wireless communication terminal. The number of subscribers for wireless communication service has been increased geometrically because of the mobility and the wireless communication terminals have been common used by many users recently.

The users of the wireless communicational terminal wish to receive various supplementary services through the wireless communication terminal. Accordingly, a camera phone has been introduced and popular among users of the wireless communication terminal. Especially, a wireless communication terminal including a built-in micro digital camera becomes very popular since a user can take a photograph of a target object and instantly transmit the photograph to a correspondent. Since the camera phone provides a photograph having an image quality similar to a general digital camera according to rapid development of the digital camera technology, the digital camera becomes a necessary function of a wireless communication terminal.

However, such a built-in digital camera generally dose not include a flash function. Accordingly, it is impossible to take a picture of an object in the night or a dark place using the conventional wireless communication terminal having the built-in digital camera. Furthermore, the conventional wireless communication terminal having the built-in digital camera may produce a picture having degraded image quality when a picture of an object is took in an indoor place having less amount of light.

In order to overcome such a problem, a manual flash is equipped in the conventional wireless communication terminal. The manual flash is turned on/off manually by a user according to a peripheral environment. However, it is very annoying to a user to manually turn on/off the flash. Furthermore, it is very difficult to decide to turn on/off the flash since a user subjectively analyzes a proper exposure tendency according to the peripheral environment.

In order to overcome the problem of the manual flash, a conventional auto flash function is introduced. The conventional auto flash function automatically turns on/off the flash by controlling a voltage value inputted to a general purpose input/output pin (GPIO) of a controller according to brightness of a lighting. To control the voltage value, a luminance sensor is used. The luminance sensor recognizes an amount of light and converts the amount of light to an electric signal.

However, the conventional auto flash function requires embedding of the additional luminance sensor in a wireless communication terminal so a certain space of the wireless communication terminal is occupied by the luminance sensor. Since light must directly contact to the luminance sensor, a mechanical structure of the wireless communication terminal is limited by the luminance sensor. Furthermore, a manufacturing cost of the wireless communication terminal increases.

Recently, a conventional method of automatically turning on/off a flash by reading brightness of an image signal of a camera is introduced. However, information of peripheral environment is not accurately detected since a flash is controlled using a signal generated after image correction.

### SUMMARY OF THE INVENTION

It is, therefore, an object of the present invention to provide a wireless communication terminal having a function for automatically turning on/off a flash according to brightness of an image signal using a register value, which is a gain value of a programmable gain amplifier (PGA), used in a camera unit of the wireless communication terminal without requiring an operation of a user or additional equipments.

In accordance with an aspect of the present invention, there is provided a wireless communication terminal having a function of automatically turning on/off a flash, including: an image capturing unit for obtaining an image of an object in real-time, converting the obtained image to an electric image signal, and automatically controlling a gain according to brightness of the electric image signal; an input unit for receiving an image capturing signal; a controller for confirming a gain value of an image signal which is automatically controlled in the image capturing unit when the image capturing signal is inputted through the input unit, comparing the confirmed gain value of the image signal with a predetermined threshold value, and generating a control signal according to the comparison signal; and a light emitting unit for emitting light in response to the control signal from the controller;

In accordance with an aspect of the present invention, there is also provided a method of automatically controlling a flash in a wireless communication terminal, the method including the steps of: obtaining an image of an object when an image capturing signal is inputted; converting the obtained image to an electric image signal and controlling a gain value according to brightness of the image signal; determining whether the brightness of the image signal, which is controlled according to the gain value, is proper or not; re-controlling the gain value when the brightness of the image signal is not proper and comparing the gain value and a predetermined threshold value when the brightness of the image signal is proper; and outputting a control signal to turn on/off a light emitting unit according to the comparison result.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a block diagram for explaining a conventional method of auto flash in a wireless communication terminal;

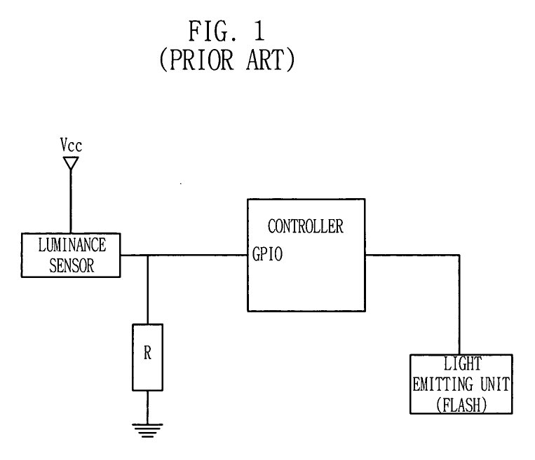

FIG. 2 is a block diagram illustrating a wireless communication terminal having a function for automatically controlling a flash in accordance with a preferred embodiment of the present invention;

FIG. 3 is a block diagram showing a camera unit of a wireless communication terminal having a function of automatically controlling a flash in accordance with a preferred embodiment of the present invention; and

FIG. 4 is a flowchart of a method for automatically controlling a flash in a wireless communication terminal in accordance with a preferred embodiment of the present invention.

### DETAILED DESCRIPTION OF THE INVENTION

Hereinafter, a wireless communication terminal having a function for automatically controlling a flash and a method thereof in accordance with a preferred embodiment of the present invention will be described in more detail with reference to the accompanying drawings.

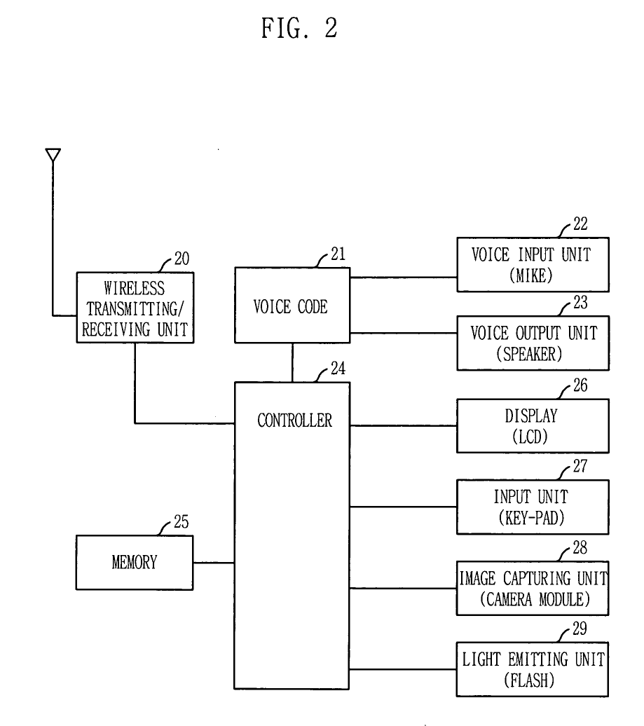

FIG. 2 is a block diagram illustrating a wireless communication terminal having a function for automatically controlling a flash in accordance with a preferred embodiment of the present invention.

As shown in FIG. 2, a wireless communication terminal having a function of automatically controlling a flash according to the present embodiment includes a wireless transmitting/receiving unit 20, a voice coder and decoder (CODEC) 21, a voice input unit 22 such as a MICROPHONE (MIKE), a voice output unit 23 such as a speaker, a controller 23, a memory 25, a display 26 such as a liquid crystal display (LCD), an input unit 27 such as a keypad, an image capturing unit 28 such as a camera module, and a light emitting unit 29 such as a flash.

The wireless transmitting/receiving unit 20 transmits and receives a signal through a wireless communication link using an antenna.

The voice CODEC 21 receives a signal from the wireless transmitting/receiving unit 20 in response to a control of the controller 25, converts the received signal to a voice, and outputs the voice through the voice output unit 23. The voice CODEC 21 also converts a voice inputted through the voice input unit 22 to a signal, transfers the signal to the controller 24, and transmits the signal through the wireless transmitting/receiving unit 20.

The voice input unit 22 receives a voice and transfers the received voice to the voice CODEC 21. The voice output unit 23 outputs the voice transferred from the voice CODEC 21.

The memory 25 stores programs for driving the wireless communication terminal, file systems for images, characters and icons, and image data.

The controller 24 receives a signal to take a photo from a user through the input unit 27, checks a gain value which is automatically controlled in the image capturing unit 28 according to brightness of an image signal, compares the checked gain value to a predetermined threshold value, and turns on/off the light emitting unit 29 according to the comparison result.

Herein, the predetermined threshold value is a reference value for turning on/off the light emitting unit 29. The gain value of the image capturing unit 28 is larger than the threshold value when an image is analyzed as a comparative darker. Therefore, the light emitting unit 29 is turned on by outputting an enable signal to the light emitting unit 29. On the contrary, the gain value of the image capturing unit 28 is smaller than the threshold value when an image is analyzed as comparative brighter. Therefore, the light emitting unit 29 is turned off by outputting a disenable signal to the light emitting unit 29.

Herein, the controller 24 checks the gain value of the image capturing unit 28 by regularly monitoring the image capturing unit 28 using an inter integrated circuit (IIC) communication.

The display 26 provides various interfaces and images to a user. For example, the display 26 displays a preview image of captured image to a user of the wireless communication terminal in response to a control of the controller 24. The input unit 27 receives an image capturing signal for capturing an image of object from a user.

The image capturing unit 28 captures an image of a target object in real-time, converts the captured image to an image signal, and automatically controls a gain according to bright of the image signal.

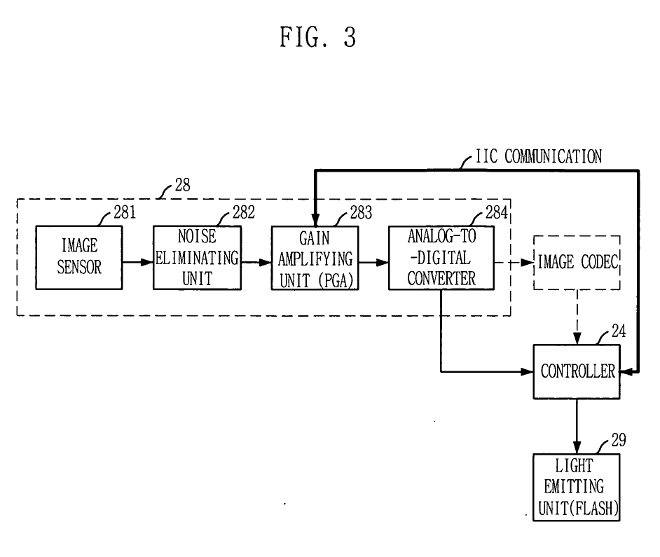

Herein, a programmable gain amplifier (PGA) in the image capturing unit 28 automatically controls the gain according to brightness of the image signal. It will be described in more detail with reference to FIG. 3.

The light emitting unit 29 emits lights in response to a control of the controller 24.

FIG. 3 is a block diagram showing a camera unit of a wireless communication terminal having a function for automatically controlling a flash in accordance with a preferred embodiment of the present invention.

As shown in FIG. 3, the image capturing unit 28 of the wireless communication terminal having the function of automatically controlling a flash includes an image sensor 281, a noise eliminating unit 282, a gain amplifying unit 283, and an analog-to-digital converter 284.

The image sensor 281 obtains an image of an object and converts the obtained image to an image signal.

Representative examples of the image sensor 281 are a charge coupled device (CCD) sensor and a complementary metal oxide semiconductor (CMOS) sensor. Any image sensor suitable to a specification of a wireless communication terminal may be used.

The noise eliminating unit 282 eliminates noises of the image signal obtained from the image sensor 281 through a correlated double sampling (CDS) function.

The gain amplifying unit 283 receives the noise eliminated image signal from the noise eliminating unit 282 and controls a gain according to brightness of received image signal using a programmable gain amplifier (PGA).

The gain amplifying unit 283 amplifies a gain level to brighten the image when brightness of image is analyzed as too dark, and lowers the gain level to darken the image when brightness of image is analyzed as too bright.

Since the gain of the gain amplifier 283 is varied according to the brightness of image signal, the controller 24 dynamically controls the light emitting unit 29 by regularly monitoring the brightness of the image through the IIC communication.

The A/D converter 284 receives an analog image signal through the gain amplifying unit 283 and converts the received analog image signal to a digital image signal to transfer to an image CODEC or the controller 24 of the wireless communication terminal.

Hereinafter, the image CODEC shown in FIG. 3 will be explained in detail. The image CODEC is not shown in FIG. 2.

The image CODEC is arranged at an outside of the controller 24 in a conventional wireless communication terminal. The image CODEC is generally included in the controller 24 of a recently developed wireless communication terminal.

Accordingly, the digital image signal may be transferred to the controller 24 through the image CODEC or directly to the controller 24 according to a type of a wireless communication terminal. Therefore, the image CODEC is shown in FIG. 3 using a dotted line.

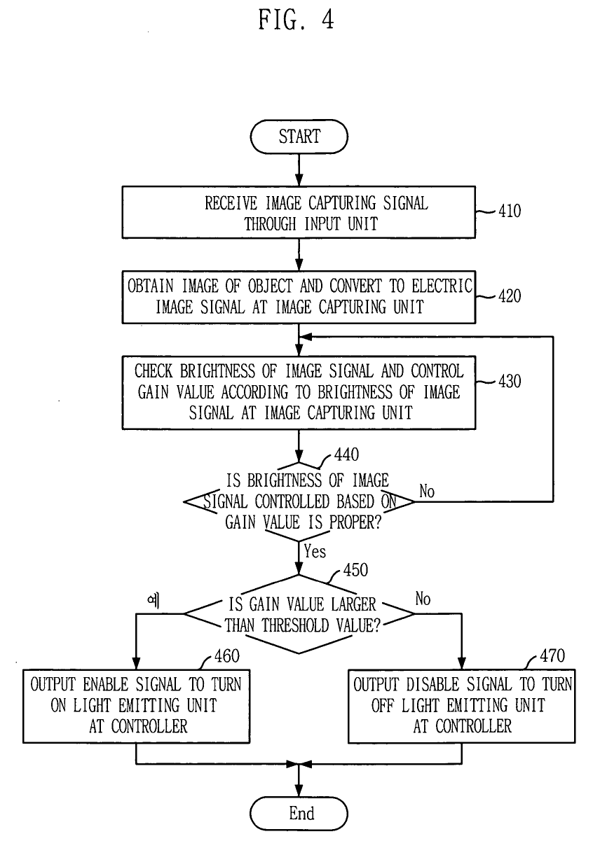

FIG. 4 is a flowchart of a method for automatically controlling a flash in a wireless communication terminal in accordance with a preferred embodiment of the present invention.

At first, the wireless communication terminal receives an image capturing signal through the input unit 27 at step S410.

The image capturing unit 28 captures an image of an object and converts the captured image to an electric image signal at step S420.

The image capturing unit 28 analyzes brightness of the image signal and controls a gain value according to the analysis result at step S430.

After controlling, the image capturing unit 28 determines whether the brightness of the image signal controlled according to the gain value is proper or not at step S440.

If the brightness of the controlled image signal is not proper at step S440, the gain value of the image signal is re-controlled at step S430. On the contrary, if the brightness of the controlled image signal is proper at step S440, the wireless communication terminal determines whether the gain value is larger than the predetermined threshold value at step S450.

The controller 24 of the wireless communication terminal performs the step S450 for determining whether the gain value is larger than the predetermined threshold value. The controller 24 consistently monitors the image capturing unit 28 using the IIC communication, and compares the gain value and the threshold value when the brightness of the image signal is proper.

If the predetermined threshold value is larger than the gain value at step S450, the controller 24 outputs an enable signal to the light emitting unit 29 to turn on the light emitting unit 29. On the contrary, if the predetermined threshold value is smaller than the gain value at step S450, the controller 24 outputs a disable signal to the light emitting unit 29 to turn off the light emitting unit 29.

If the light emitting unit 29 is already turned on when the controller 24 outputs the disable signal to the light emitting unit 29, the light emitting unit 29 is turned off by the disable signal. But if the light emitting unit 29 is turned off when the controller 24 outputs the disable signal to the light emitting unit 29, the light emitting unit 29 is maintained as a turn off state.

As described above, the image capturing unit 28 of the wireless communication terminal automatically turns on/off the light emitting unit 29 using a gain value which is automatically controlled according to the brightness of an image signal.

The wireless communication terminal having the function of automatically controlling the flash according to the present invention maximizes a user's convenience by automatically turning on/off the flash without additional user's operations.

The wireless communication terminal having the function of automatically controlling the flash according to the present invention uses a register value used in the image capturing unit to automatically turn on/off the light emitting unit without requiring additional equipments or circuits. Therefore, a manufacturing cost is not increased by the additional equipment or circuit.

The present application contains subject matter related to Korean patent application No. KR 2004-0106264, filed in the Korean patent office on Dec. 15, 2004, the entire contents of which being incorporated herein by reference.

While the present invention has been described with respect to certain preferred embodiments, it will be apparent to those skilled in the art that various changes and modifications may be made without departing from the spirits and scope of the invention as defined in the following claims.

What is claimed is:

1. A wireless communication terminal having a function for automatically turning on/off a flash, comprising:
an image capturing unit for obtaining an image of an object in real-time, converting the obtained image to an electric image signal, and automatically controlling a gain according to brightness of the electric image signal;
an input unit for receiving an image capturing signal;
a controller for confirming a gain value of an image signal which is automatically controlled in the image capturing unit when the image capturing signal is inputted through the input unit, comparing the confirmed gain value of the image signal with a predetermined threshold value, and generating a control signal according to the comparison signal; and
a light emitting unit for emitting light in response to the control signal from the controller.

2. The wireless communication terminal having a function of automatically turning on/off a flash as recited in claim 1, wherein the image capturing unit includes:
an image capturing element for obtaining an image of an object and converting the obtained image to an electric image signal;
a noise eliminating unit for eliminating noises of the image signal obtained from the image capturing element;
a gain amplifying unit for controlling a gain value according to brightness of the image signal transferred from the noise eliminating unit; and
an analog-to-digital converter for converting an analog image signal transferred from the gain amplifying unit to a digital image signal.

3. The wireless communication terminal having a function of automatically turning on/off a flash as recited in claim 2, wherein the controller confirms the gain value of the gain amplifying unit through an IIC (inter integrated circuit) communication.

4. The wireless communication terminal having a function of automatically turning on/off a flash as recited in claim 1, wherein the controller outputs an enable signal as the control signal to turn on the light emitting unit when the gain value is larger than a predetermined threshold value, and outputs a disable signal as the control signal to turn off the light emitting when the gain value is smaller than the predetermined threshold value.

5. A method for automatically controlling a flash in a wireless communication terminal, the method comprising the steps of:
obtaining an image of an object when an image capturing signal is inputted;
converting the obtained image to an electric image signal and controlling a gain value according to brightness of the image signal;
determining whether the brightness of the image signal, which is controlled according to the gain value, is proper or not;
re-controlling the gain value when the brightness of the image signal is not proper and comparing the gain value and a predetermined threshold value when the brightness of the image signal is proper; and
outputting a control signal to turn on/off a light emitting unit according to the comparison result.

6. The method as recited in claim 5, wherein in the outputting of the controlling signal, an enable signal is outputted as the control signal to turn on the light emitting unit when the gain value is larger than the predetermined threshold value, and a disable signal is outputted as the control signal to turn off the light emitting unit when the gain value is smaller than the predetermined threshold value.
